(19) United States
(12) Patent Application Publication
(10) Pub. No.: US 2015/0138145 A1
(43) Pub. Date: May 21, 2015

(54) TOUCH SCREEN CONTROLLER TO GENERATE SINGLE-ENDED TOUCH SIGNAL, AND TOUCH SCREEN SYSTEM AND DISPLAY APPARATUS INCLUDING THE SAME

(71) Applicant: SAMSUNG ELECTRONICS CO., LTD., Suwon-si (KR)

(72) Inventors: Hee-chang Hwang, Seoul (KR); Yoon-kyung Choi, Seoul (KR); Ki-duk Kim, Hwaseong-si (KR); Jong-seon Kim, Seongnam-si, (KR); Jong-kang Park, Hwaseong-si (KR)

(73) Assignee: SAMSUNG ELECTRONICS CO., LTD., Suwon-si (KR)

(21) Appl. No.: 14/532,153

(22) Filed: Nov. 4, 2014

(30) Foreign Application Priority Data
Nov. 20, 2013 (KR) 10-2013-0141586

(51) Int. Cl. G06F 3/041; G06F 3/044

(52) U.S. Cl. CPC G06F 3/0418; G06F 3/0412; G06F 3/044
USPC 345/174

(57) ABSTRACT

A touch screen controller, a touch screen system, and a display apparatus including the same includes a touch data generator that supplies a first transmission signal to a first sensing line, supplies a second transmission signal to a second sensing line adjacent to the first sensing line, receives differential touch signals from the first and second sensing lines, and performs an arithmetic operation on the differential touch signals to generate a single-ended touch signal, and a control logic that calculates touch coordinates by using the single-ended touch signal from the touch data generator. At least one of phases and frequencies of the first and second transmission signals have different values.

### CROSS-REFERENCE TO RELATED APPLICATIONS

This application claims under U.S.C. §119 from Korean Patent Application No. 10-2013-0141586, filed on Nov. 20, 2013, in the Korean Intellectual Property Office, the disclosure of which is incorporated herein in its entirety by reference.

### BACKGROUND

1. Field

The inventive concept relates to a touch screen controller, and more particularly, to a touch screen controller to generate a single-ended touch signal, and a touch screen system and a display apparatus including the same.

2. Description of the Related Art

Flat panel display apparatuses, such as liquid crystal display (LCD) apparatuses, organic light-emitting diode (OLED) display apparatuses, etc., are being generally used to output a screen. Flat panel display apparatuses include a panel that displays an image, and a plurality of pixels are arranged in the panel. A display driving integrated circuit (IC) (hereinafter referred to as a DDI) is used to drive the panel, and the pixels are driven by data signals (display data) supplied from the DDI, thereby displaying an image in the panel.

A touch screen system may include a touch screen panel and a touch screen controller. The touch screen panel (for example, a capacitive touch screen panel) includes a plurality of sensing units, and when an object such as a finger or a touch pen approaches or touches a screen, a capacitance values of a sensing unit is changed. A touch screen processor senses the capacitance change of the sensing unit through a sensing line to generate touch data, and by processing the touch data, the touch screen processor determines whether the finger or the touch pen touches the touch screen panel and a touched position.

As an example of a signal processing method that generates touch data, a conventional differential input method may be applied. In the conventional differential input method, differential touch signals are input from adjacent sensing lines, and touch data with no common mode noise are obtained from the differential touch signals. However, the conventional differential input method needs an additional complicated processing operation for obtaining a single-ended touch signal, and an error, such as an error term being generated, occurs in the additional complicated processing operation. As another example of the signal processing method that generates touch data, a conventional single-ended input method may be used. However, it is difficult to remove a common mode noise in the conventional single-ended input method, and the number of processing blocks used to process sensing signals increases in the conventional single-ended input method.

### SUMMARY

The inventive concept provides a touch screen controller, a touch screen system including the same, and a display apparatus including the same, which enhance accuracy in generating touch data from a sensing signal, and reduces the number of sensing blocks, thereby optimizing an implementation area.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a touch screen controller including a touch data generator that supplies a first transmission signal to a first sensing line, supplies a second transmission signal to a second sensing line adjacent to the first sensing line, receives differential touch signals from the first and second sensing lines, and performs an arithmetic operation on the differential touch signals to generate a single-ended touch signal, and a control logic that calculates touch coordinates by using the single-ended touch signal from the touch data generator, wherein at least one of phases and frequencies of the first and second transmission signals has a different value from the other one thereof.

The touch data generator may include a transmission signal generator that generates the first and second transmission signals having the same frequency and different phases.

The touch data generator may further include a touch signal receiver that receives the differential touch signals which are excited according to the first and second transmission signals being supplied.

The touch data generator may further include a signal processing unit, and the signal processing unit may include a first demodulator that demodulates a first touch signal from the first sensing line, and a second demodulator that demodulates a second touch signal from the second sensing line, the signal processing unit performing an arithmetic operation on outputs of the first and second demodulators to calculate at least one differential signal corresponding to the differential touch signals.

The touch data generator may further include a single-ended signal generator that generates a first single-ended touch signal corresponding to the first sensing line and a second single-ended touch signal corresponding to the second sensing line, based on an arithmetic operation using the at least one differential signal.

In a first stage, the touch data generator may generate the first and second transmission signals having the same phase, and in a second stage, the touch data generator may generate the first and second transmission signals having different phases.

The touch data generator may generate a first differential signal by performing a demodulation and subtraction operation on a first differential touch signal received in the first stage, generate a second differential signal by performing a demodulation and subtraction operation on a second differential touch signal received in the second stage, and generate the single-ended touch signal by performing an arithmetic operation on the first and second differential signals.

The touch data generator may generate a first single-ended touch signal corresponding to the first sensing line, based on a subtraction operation for the first and second differential signals, and generate a second single-ended touch signal corresponding to the second sensing line, based on a summation operation for the first and second differential signals.

The touch data generator may receive two base signals having different phases, combine the two base signals in a first scheme to generate the first transmission signal, and combine the two base signals in a second scheme to generate the second transmission signal.

The touch data generator may perform a first demodulation operation on the differential touch signals to generate first and second signals, perform a second demodulation operation on the differential touch signals to generate third and fourth signals, perform an arithmetic operation on the first and second signals to generate a first differential signal, and perform an arithmetic operation on the third and fourth signals to generate a second differential signal.

The touch data generator may generate a first single-ended touch signal corresponding to the first sensing line, based on a subtraction operation for the first and second differential signals, and generate a second single-ended touch signal corresponding to the second sensing line, based on a summation operation for the first and second differential signals.

The touch data generator may receive at least one base signal, code the at least one base signal to generate the first and second transmission signals, perform a first arithmetic operation on the differential touch signals to generate a first single-ended touch signal corresponding to the first sensing line, and perform a second arithmetic operation on the differential touch signals to generate a second single-ended touch signal corresponding to the second sensing line.

The foregoing and/or other features and utilities of the present general inventive concept may also be achieved by providing a touch screen controller including a transmission signal generator that generates first and second transmission signals of which at least one of frequencies and phases have different values, supplies the first transmission signal to a first sensing line, supplies the second transmission signal to a second sensing line adjacent to the first sensing line, a touch signal receiver that receives differential touch signals from the first and second sensing lines, and a signal processing unit that processes the differential touch signals to output at least one signal which is used to calculate touch coordinates.

The foregoing and/or other features and utilities of the present general inventive concept may also be achieved by providing a display driving integrated circuit (DDI) including a display driver that realizes an image in a panel, and a touch screen controller that senses a touch motion of touching a touch screen panel, wherein the touch screen controller comprises a touch data generator that supplies a first transmission signal to a first sensing line of the touch screen panel, and supplies a second transmission signal to a second sensing line adjacent to the first sensing line, at least one of phases and frequencies of the first and second transmission signals having different values.

The foregoing and/or other features and utilities of the present general inventive concept may also be achieved by providing an operating method of a touch screen controller including supplying a first transmission signal to a first sensing line, supplying a second transmission signal to a second sensing line adjacent to the first sensing line, at least one of phases and frequencies of the first and second transmission signals having different values, receiving differential touch signals from the first and second sensing lines, performing a demodulation and calculation operation on the differential touch signals, and performing an arithmetic operation on a differential signal, which is obtained through the demodulation and calculation operation, to generate first and second single-ended touch signals respectively corresponding to the first and second sensing lines.

The foregoing and/or other features and utilities of the present general inventive concept may also be achieved by providing a computer-readable medium to contain computer-readable codes as a program to execute the methof described above or hereinafter.

The foregoing and/or other features and utilities of the present general inventive concept may also be achieved by providing a touch screen controller usable with an electronc appatratus, the touch screen controller including a touch data generator to supply at least two transmission signals having at least two different characteristics to sensing lines of a touch screen panel, to receve differential touch signals from the sensing lines in response to the at least two transmission signals having the at least two different characteristics, and to generate a single-ended touch signal from the differential touch signals using at least one of an arithmetic operation and a demodulation operation.

The different characteristics may inlcude a phase and a frequency, and at least one of phases and frequencies of the transmission signals may have a different value from the other one thereof. When the transmission signals are generated through a modulation, the touch data generator may include a demodulator to perform a demodulation operation on the differential touch signal to generate the signal-ended touch signal, and when the transmission signals are generated through a time division method, the touch data generator may perform the arithmetic operation to generate the singl-ended touch signal.

The touch screen controller may further include a signal processing unit having one of an amplifier and a demodulator to receive touch input signals from the sensing lines and to generate the differential touch signals from the received touch input signals.

The touch screen controller may further include a signal processing unit having a demodulator and a calculation unit to receive the differential touch signals with a common noise occurring from a relationship between adjacent sensing lines, and to generate a differential signal without a common noise from the differential touch signals, and a generator having a calculation unit and a register to generate the single-ended touch signal from the differential signal without the common noise.

The electronic apparatus may include a display apparatus, the display apparatus may have a display panel, a display device integrated circuit to control the display panel to display an image thereon, and the touch screen panel having the sensing lines. The touch screen controller may be intergrated into the display device integrated circuit.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a touch screen system including a touch screen controller according to an embodiment of the inventive concept;

FIG. 2A is a block diagram illustrating a touch screen panel having sensing units to generate parasitic capacitance components in a touch screen system;

FIG. 2B is a graph illustrating parasitic capacitance components which are generated in sensing units of a touch screen panel of FIG. 2A;

FIG. 3 is a block diagram illustrating a touch screen controller according to an embodiment of the inventive concept;

FIG. 4 is a block diagram illustrating a touch data generator of the touch screen controller of FIG. 3;

FIG. 5 is a block diagram illustrating the touch data generator of the touch screen controller of FIG. 4;

FIG. 6 is a diagram illustrating an example of a touch screen panel including a plurality of horizontal lines and vertical lines;

FIG. 7 is a block diagram illustrating a touch data generator of a touch screen controller to generate a single-ended touch signal from a differential touch signal according to an embodiment of the inventive concept;

FIG. 8 is a circuit diagram illustrating the touch data generator of FIG. 7 according to an embodiment of the inventive concept;

FIG. 9 is a waveform diagram illustrataing an example of a modulated transmission signal in the touch data generator of FIG. 8;

FIG. 10 is a table illustrating signals respectively applied to a plurality of nodes of the touch date generator of FIG. 8;

FIG. 11 is a flowchart illustrating an operating method of a touch screen controller according to an embodiment of the inventive concept;

FIG. 12 is a flowchart illustrating an operating method of a touch screen controller according to an embodiment of the inventive concept;

FIG. 13 is a block diagram illustrating a touch data generator of a touch screen controller according to an embodiment of the inventive concept;

FIG. 14 is a circuit diagram illustrating the touch data generator of FIG. 13 according to an embodiment of the inventive concept;

FIG. 15 is a waveform diagram illustrating an example of a modulated transmission signal in the touch data generator of FIG. 14;

FIG. 16 is a table illustrating signals respectively applied to a plurality of nodes of the touch data generator of FIG. 14;

FIG. 17 is a flowchart illustrating an operating method of a touch screen controller according to another embodiment of the inventive concept;

FIG. 18 is a block diagram illustrating a touch DDI including a touch screen controller according to an embodiment of the inventive concept;

FIG. 19 is a diagram illustrating a printed circuit board (PCB) structure of a display apparatus integrated with a touch screen panel according to an embodiment of the inventive concept;

FIG. 20 is a diagram illustrating a display apparatus equipped with a semiconductor chip with a built-in touch screen controller according to an embodiment of the inventive concept; and

FIG. 21 is a block diagram illustrating a user apparatus including a touch screen controller according to an embodiment of the inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

As used herein, the term “and/or” includes any and all combinations of one or more of the associated listed items. Expressions such as “at least one of,” when preceding a list of elements, modify the entire list of elements and do not modify the individual elements of the list.

The attached drawings for illustrating preferred embodiments of the inventive concept are referred to in order to gain a sufficient understanding of the inventive concept, the merits thereof, and the objectives accomplished by the implementation of the inventive concept.

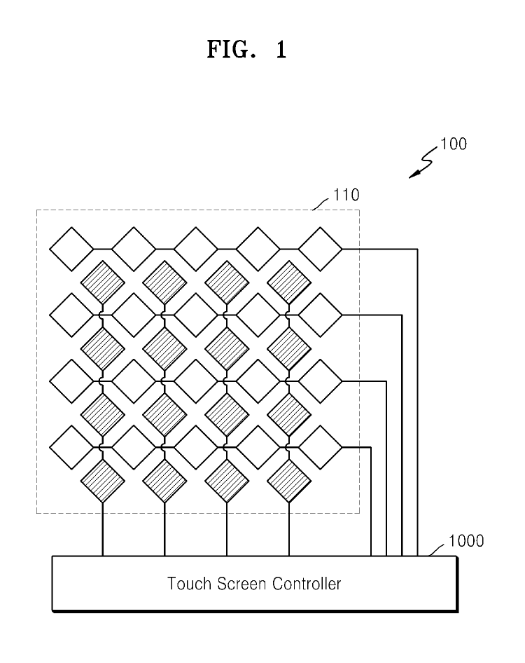

FIG. 1 is a block diagram illustrating a touch screen system 100 according to an embodiment of the inventive concept. The touch screen system 100 includes a touch screen panel 110, which includes a plurality of sensing units, and a touch screen controller 1000 that senses a capacitance change of each sensing unit of the touch screen panel 110, and processes the capacitance change to determine the presence (existence or performance) of a touch operation and a touched position of a touch screen corresponding to the touch operation. The touch screen panel 110 generates a line capacitance change according to a touch (or hovering) by an object (or a conductor) such as a finger or a touch pen, and supplies the line capacitance change to the touch screen controller 1000. In order to detect a touched position or a hovering position, the touch screen panel 110 may include a lattice structure including a plurality of horizontal lines and vertical lines. The touching (hovering) motion or touching (hovering) operation may include touching the touch screen panel 110 using a conductor such as the finger or the touch pen, and approaching the touch screen panel 110 using the conductor.

The touch screen panel 110 includes the plurality of sensing units, and for example, the touch screen panel 110 includes a plurality of sensing units, which are arranged in a first direction, for example, a row direction, and a plurality of sensing units which are arranged in a second direction, for example, a column direction. As illustrated in FIG. 1, the touch screen panel 110 includes a plurality of rows on which a sensing unit is disposed, that is, a plurality of sensing units are arranged on each of the plurality of rows. The sensing units arranged on each row are electrically connected to each other. Also, the touch screen panel 110 includes a plurality of columns on which a sensing unit is disposed, that is, a plurality of sensing units are arranged on each of the plurality of columns. The sensing units arranged on each column are electrically connected to each other.

The touch screen controller 1000 generates a sensing signal by sensing a capacitance change of each sensing unit of the touch screen panel 110, and processes the sensing signal to generate touch data. For example, by sensing the capacitance changes of the sensing units of the plurality of rows and the plurality of columns, the touch screen controller 1000 determines whether the touch screen panel 110 is touched and a touched position.

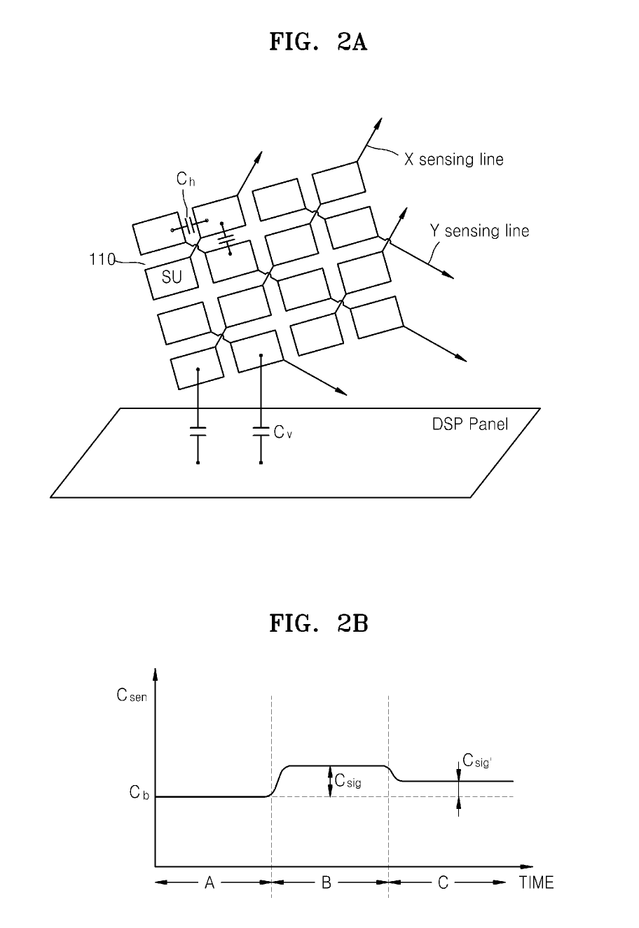

FIG. 2A is a block diagram illustrating parasitic capacitance components which are generated in sensing units of the touch screen panel 110 of FIG. 1, and FIG. 2B is a graph illustrating parasitic capacitance components which are generated in sensing units of the touch screen panel 110 of FIG. 1.

As illustrated in FIG. 2A, the touch screen panel 110 includes a plurality of sensing units SU, which may be disposed adjacent to a display panel (DSP panel) to display an image or attached to the display panel. For example, the display panel of FIG. 2A corresponds to an upper substrate of a display panel which receives an electrode voltage (VCOM). For example, the electrode voltage may be supplied as a common electrode voltage to the upper substrate of a liquid crystal display panel, and in an organic light-emitting display panel, a cathode voltage that is a direct current (DC) voltage may be supplied to the upper substrate.

The touch screen panel 110 includes a plurality of sensing units SU, which are connected to a plurality of sensing lines arranged in a row direction (an x direction), and a plurality of sensing units SU which are connected to a plurality of sensing lines arranged in a column direction (a y direction). Capacitance values of the sensing units are changed according to a touch motion. The touch screen panel 110 may sense the capacitance changes of the sensing units through a plurality of sensing lines, and the touch screen controller 1000 may process sensing signals corresponding to the capacitance changes to generate touch data and to determine whether the touch screen panel 110 is touched and a touched position according to the touch data.

Each of the sensing units SU has a parasitic capacitance component due to an arrangement structure of the sensing units SU. For example, the parasitic capacitance component may include a horizontal parasitic capacitance component Ch, which is generated between adjacent sensing units, and a vertical parasitic capacitance component Cv that is generated between a sensing unit and the display panel.

As illustrated in FIG. 2B, each sensing unit SU has a basic capacitance component Cb including the parasitic capacitance component, and a capacitance value of each sensing unit SU is changed by a proximity or touch of an object such as a finger or a touch pen. For example, when a conductive object approaches or touches a sensing unit SU, a capacitance value of the sensing unit SU is changed. In a section A of FIG. 2A where the conductive object does not touch the sensing unit SU, the capacitance value of the sensing unit SU may have a value Cb. A section B of FIG. 2B denotes a case in which the conductive object touches the sensing unit SU, and a section C of FIG. 2B denotes a case in which the conductive object approaches the sensing unit SU. As illustrated, when the conductive object touches the sensing unit SU, an amount Csig of the capacitance value may increase with respect to the value Cb, and when the conductive object approaches the sensing unit, an amount Csig′ of the capacitance value may be relatively smaller than the value Csig.

This is merely an example, and by changing a design of the arrangement structure of the sensing units, a capacitance value may be changed by another method. For example, the design of the arrangement structure of the sensing units may be changed so that when the conductive object touches or approaches a sensing unit, a capacitance value decreases.

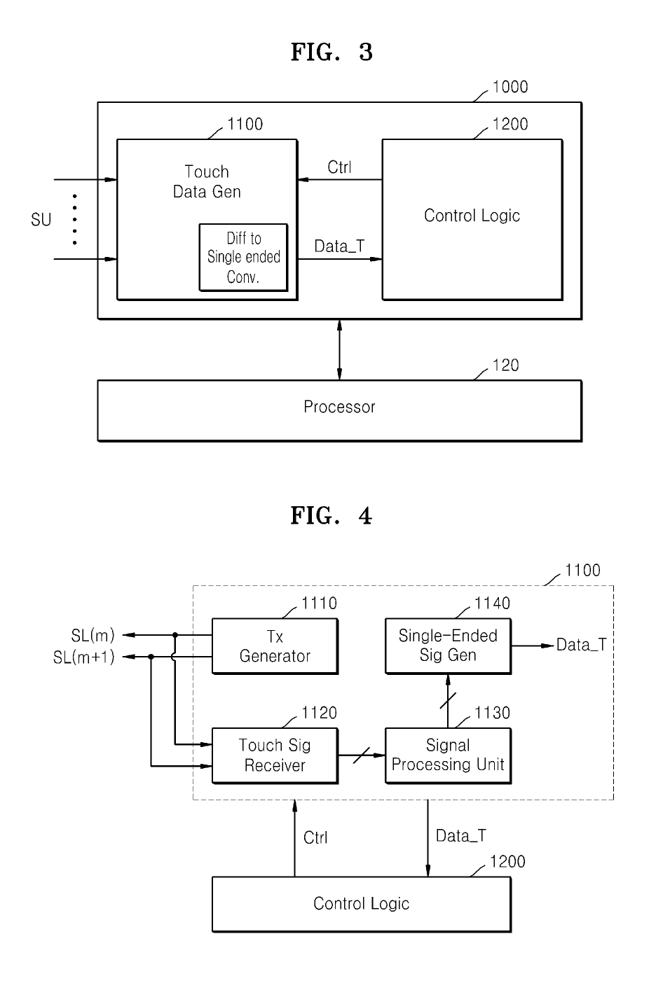

FIG. 3 is a block diagram illustrating a touch screen controller 1000 according to an embodiment of the inventive concept. FIG. 3 illustrates a processor 120 connectable to the touch screen controller 1000 to process touch information (for example, information about the presence of a touch and a touched position).

The touch screen controller 1000 may include a touch data generator 1100 and acontrol logic 1200. The control logic 1200 performs an overall control operation of an internal circuit of the touch screen controller 1000. The overall control operation may be in association with an operation of a touch screen. Also, the touch data generator 1100 is electrically connected to a plurality of sensing units SU through a plurality of sensing lines, and senses capacitance changes of the sensing units SU based on a touch motion to generate sensing signals. Also, the touch data generator 1100 processes the generated sensing signals to generate and output touch data Data_T. The control logic 1200 or the processor 120 may perform a logic operation based on the touch data Data_T to determine whether the touch screen is touched and a position at which a touch motion has been performed.

The control logic 1200 may supply at least one control signal Ctrl to the touch data generator 1100 to perform a sensing operation and a touch data generating operation. For example, the touch data generator 1100 may control various operations such as sampling for internally generating a signal (for example, a transmission signal to the touch screen panel) and the touch data Data_T in response to the control signal Ctrl. The touch data generator 1100 may correspond to an analog processing unit that processes analog signals in the touch screen controller 1000, and the control logic 1200 may correspond to a digital processing unit that performs a digital signal processing operation of received touch data Data_T to detect the presence of a touch and a touched position. Although FIG. 3 illustrates the control logic 1200 separate from the touch data generator 1100, it is possible that tht contrl logic 1200 can be included in the touch data generator 1100 or the processor 120.

According to an embodiment of the inventive concept, the touch data generator 1100 may include a converter that receives a differential touch signal based on a differential input method, and converts the differential touch signal into a single-ended touch signal suitable to detect touch coordinates. For example, the touch data generator 1100 may perform an operation that receives differential touch signals from adjacent sensing lines (two adjacent sensing lines), calculates a differential value of the differential touch signals to calculate a differential signal with no common mode noise, and performs an arithmetic operation on the differential signal to generate a single-ended signal suitable for a post-processing operation.

Moreover, according to the embodiment, the touch data generator 1100 may perform a signal processing operation based on the differential touch signal to generate single-ended touch signals respectively corresponding to adjacent sensing lines, thereby decreasing the number of sensing blocks compared to a single-ended signal input structure. Also, the single-ended touch signals may be supplied as touch data, and thus, a system (for example, the control logic 1200 or processor 120 of FIG. 3) may not perform an additional signal processing operation.

A detailed operation of the touch screen controller 1000 of FIG. 3 will now be described with reference to FIG. 4. FIG. 4 is a block diagram illustrating the touch screen controller 1000 of FIG. 3.

As illustrated in FIG. 4, the touch screen controller 1000 may include the touch data generator 1100 and the control logic 1200, and the touch data generator 1100 may include a transmission signal generator 1110, a touch signal receiver 1120, a signal processing unit 1130, and a single-ended signal generator 1140. The touch data generator 1100 may receive the at least one control signal Ctrl from the control logic 1200 to generate the touch data Data_T, and the control logic 1200 may perform an arithmetic processing operation on the touch data Data_T to detect touching, for example, the presence (existence or performance) of a touch, and a touched position (hereinafter referred to as touch coordinates).

The transmission signal generator 1110 may be disposed to correspond to adjacent sensing lines. For example, the transmission signal generator 1110 may be disposed to correspond to a pair of sensing lines. In detail, the transmission signal generator 1110 may output a transmission signal Tx to a first sensing line, corresponding to an odd-numbered sensing line, and a second sensing line corresponding to an even-numbered sensing line. Also, the transmission signal generator 1110 may change a phase and/or a frequency of the transmission signal Tx to generate signals (for example, base signals) having different phases and/or frequencies, and include a signal modulation function of multiplexing the signals having different phases and/or frequencies.

The touch signal receiver 1120 receives touch input signals of two adjacent sensing lines (hereinafter referred to as first and second sensing lines SL(m) and SL(m+1)). The touch input signals may be signals that are excited by supplying the transmission signals Tx to the sensing units through the first and second sensing lines SL(m) and SL(m+1). The touch signal receiver 1120 may include first and second amplifiers that respectively correspond to the first and second sensing lines SL(m) and SL(m+1). An output from the touch signal receiver 1120 may be supplied as a differential touch signal to the signal processing unit 1130.

The signal processing unit 1130 may perform various signal processing operations on a received differential touch signal. For example, the signal processing unit 1130 may perform a current-voltage conversion operation of converting a current into a voltage, a demodulation operation corresponding to a modulation method of a transmission signal Tx, an operation of calculating a differential value between differential touch signals, and an analog-digital conversion operation, etc. The single-ended signal generator 1140 may perform an operation of generating a single-ended touch signal by using a differential output from the signal processing unit 1130. The single-ended touch signal generated from the single-ended signal generator 1140 may be output as the touch data Data_T.

FIG. 4 illustrates the transmission signal generator 1110, the touch signal receiver 1120, the signal processing unit 1130, and the single-ended signal generator 1140 to be disposed in the the touch data generator 1100 to correspond to a pair of sensing lines (for example, the first and second sensing lines SL(m) and SL(m+1)), and the touch data generator 1100 may generate the touch data Data_T from a plurality of pairs of sensing lines, respectively. Therefore, the touch data generator 1100 may include, in plurality, various functional blocks illustrated in FIG. 4.

When the functional blocks of FIG. 4 are defined as one group, the one group including the functional blocks is disposed to correspond to a pair of sensing lines, and thus, when the total number of sensing lines is an m number, only functional blocks included in an m/2 number of groups may be providedin the touch dat generator 1100.

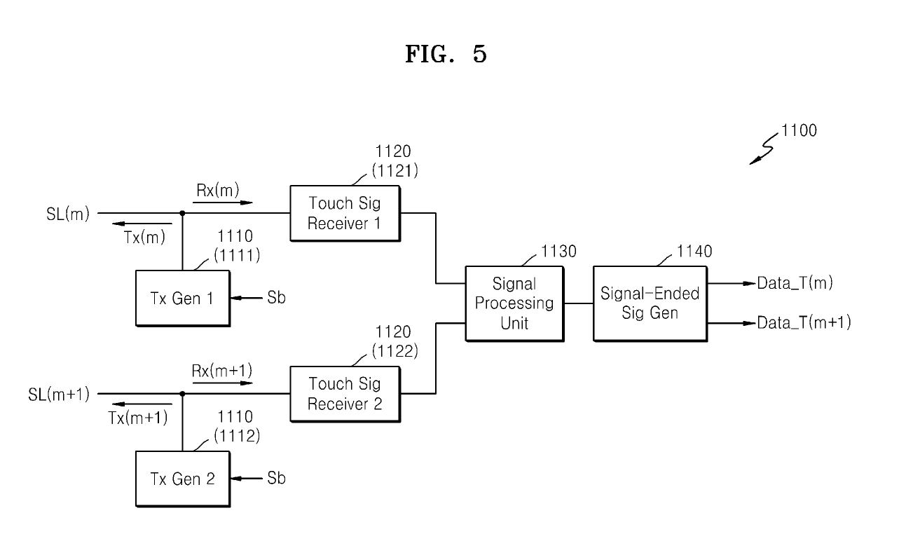

An implementation example of the touch data generator 1100 of FIG. 4 will be described with reference to FIG. 5.

As illustrated in FIG. 5, the touch data generator 1100 may include a plurality of functional blocks that generate touch data for the pair of sensing lines SL(m) and SL(m+1). The touch data generator 1100 may further include a plurality of functional blocks to correspond to respective pairs of sensing lines. The transmission signal generator 1110 of FIG. 4 may include a first transmission signal generator 1111 corresponding to the first sensing line SL(m), and a second transmission signal generator 1112 corresponding to the second sensing line SL(m+1).

Each of the first and second transmission signal generators 1111 and 1112 may generate a transmission signal having one or more characteristics, for example, a frequency and a phase, and transmit the transmission signal to the touch screen panel 110. For example, a first transmission signal Tx(m) from the first transmission signal generator 1111 may have a phase and a frequency which are different from at least one of a phase and a frequency of a second transmission signal Tx(m+1) from the second transmission signal generator 1112. In order to generate a phase and/or frequency-modulated signal, a base signal Sb may be supplied to the first and second transmission signal generators 1111 and 1112. The first and second transmission signal generators 1111 and 1112 may generate the first and second transmission signals Tx(m) and Tx(m+1) using the base signal Sb. The first and second transmission signal generators 1111 and 1112 may modulate a frequency and/or a phase of the base signal Sb to generate the first and second transmission signals Tx(m) and Tx(m+1).

In an embodiment, two or more base signals having different frequencies and/or phases may be respectively supplied to generate the first and second transmission signals Tx(m) and Tx(m+1). The first and second transmission signal generators 1111 and 1112 may temporally or spatially combine a plurality of base signals to generate the first and second transmission signals Tx(m) and Tx(m+1), respectively.

The touch signal receiver 1120 of FIG. 4 may include a first touch signal receiver 1121 corresponding to the first sensing line SL(m), and a second touch signal receiver 1122 corresponding to the second sensing line SL(m+1) as illustrated in FIG. 5. The first and second transmission signals Tx(m) and Tx(m+1) are supplied (transmitted) to the touch screen panel, and thus, a first touch signal Rx(m) and a second touch signal Rx(m+1) may be supplied to the first and second touch signal receivers 1121 and 1122. Each of the first and second touch signal receivers 1121 and 1122 may include an amplifier, and differential touch signals may be output from a pair of amplifiers of the touch signal receiver 1120.

The differential touch signals from the first and second touch signal receivers 1121 and 1122 are supplied to the signal processing unit 1130, which calculates a differential signal from the differential touch signals corresponding to a capacitance change based on a touch motion of touching the touch screen panel. A common mode noise may be removed by calculating a differential signal for the adjacent first and second sensing lines SL(m) and SL(m+1). In addition, the signal processing unit 1130 performs a current-voltage conversion operation, a demodulation operation, an arithmetic operation, and an analog-digital conversion operation to generate the differential signal. The single-ended signal generator 1140 performs a conversion operation based on the differential signal from the signal processing unit 1130 to generate a single-ended touch signal for each of the first and second sensing lines SL(m) and SL(m+1), and outputs the single-ended touch signals as touch data Data_T(m) and Data_T(m+1).

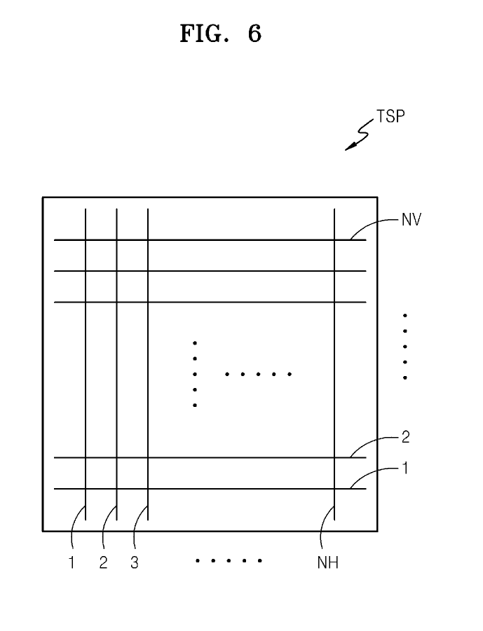

Hereinafter, a touch data generating operation according to various embodiments of the inventive concept will be described. FIG. 6 is a diagram illustrating an example of a touch screen panel TSP including a plurality of horizontal lines and vertical lines.

As illustrated in FIG. 6, the touch screen panel TSP may include an H number of horizontal lines 1 to NH and a V number of vertical lines 1 to NV. By sensing a capacitance change based on a touch motion of touching the touch screen panel TSP, the touch screen panel TSP may generate a signal corresponding to touch information including touch coordinates based on a touch (or hovering), a touch type, and a touch mobility, and may sense touch signals of all the horizontal lines 1 to NH and vertical lines 1 to NV included in the touch screen panel TSP. In sensing all the horizontal lines 1 to NH and vertical lines 1 to NV, a sensing operation may be performed at least two times or more. For example, when the number of vertical lines 1 to NV is greater than the number of horizontal lines 1 to NH (i.e., NH<NV<2*NH), a sensing operation for the vertical lines 1 to NV may be performed at least two times or more.

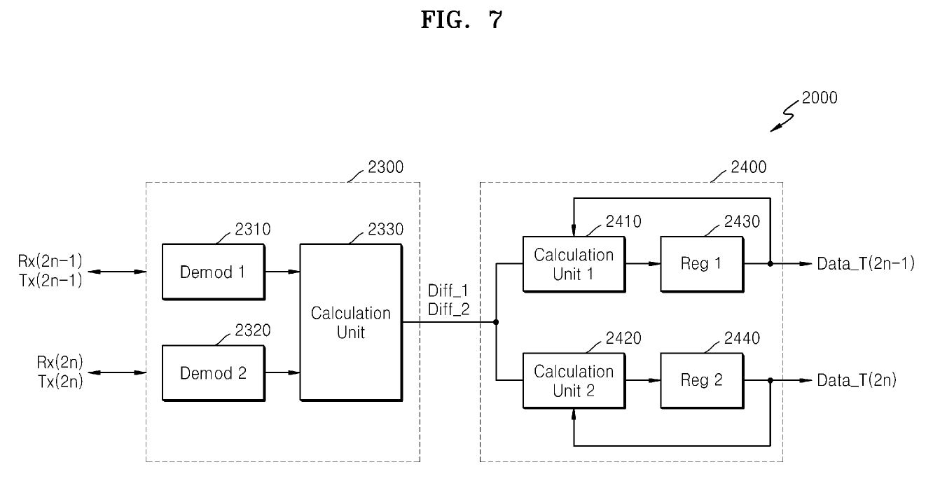

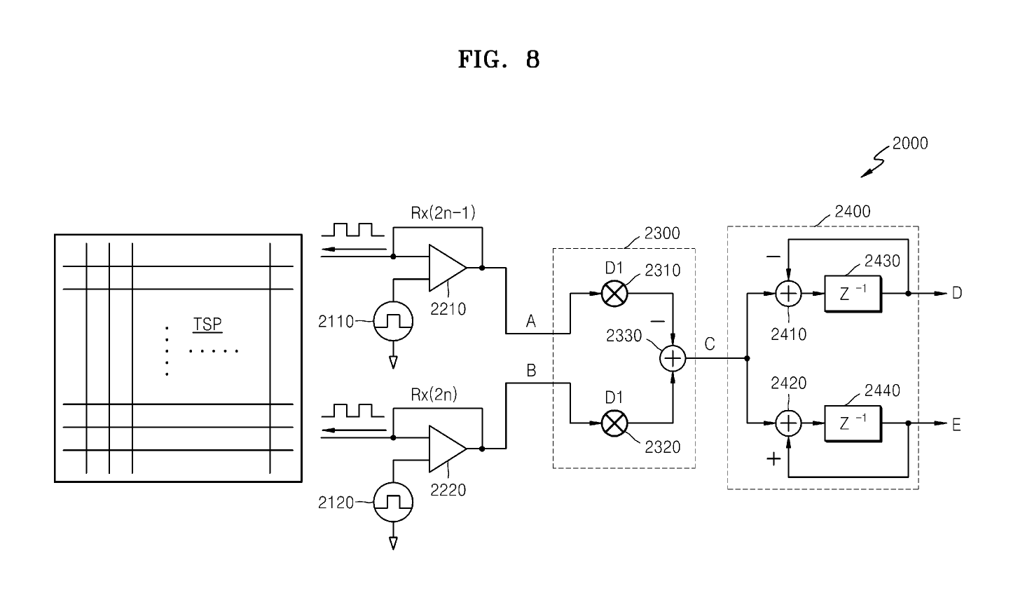

FIG. 7 is a block diagram illustrating a touch data generator 2000 to generate a single-ended touch signal from a differential touch signal. FIG. 7 illustrates a signal processing unit 2300 and a single-ended signal generator 2400 of the touch data generator of the touch screen controller 2000.

As illustrated in FIG. 7, the signal processing unit 2300 may include one or more demodulators 2310 and 2320 and a calculation unit 2330. Also, the single-ended signal generator 2400 may include one or more calculation units 2410 and 2420 and one or more registers 2430 and 2440. In illustrating a pair of sensing lines, in order to distinguish an odd-numbered sensing line and an even-numbered sensing line, a first sensing line is referred to as an odd-numbered sensing line 2n−1, and a second sensing line is referred to as an even-numbered sensing line 2n.

First and second transmission signals Tx(2n−1) and Tx(2n), having at least one characteristic, for example, a certain frequency, through a modulation operation, may be respectively supplied to adjacent sensing lines of the touch screen panel TDP, and at least one of phases and frequencies of the first transmission signal Tx(2n−1) and the second transmission signal Tx(2n) may have a different value from the other one. Also, a time division method may be applied in a modulating method to generate a transmission signal, and for example, one base signal is time-division coded into two codes (for example, 1 and 1 or 1 and −1), thereby generating the first and second transmission signals Tx(2n−1) and Tx(2n) respectively supplied to the first and second sensing lines. Also, in performing the time-division coding operation, a two-stage coding operation may be applied. For example, in a first stage (Stage 1), the first and second transmission signals Tx(2n−1) and Tx(2n) may have a same characteristic, for example, the same frequency and phase, but in a second stage (Stage 2), the first and second transmission signals Tx(2n−1) and Tx(2n) may have different characteristics, for example, the same frequency and different phases. For example, in the second stage (Stage 2), the first and second transmission signals Tx(2n−1) and Tx(2n) may have a 180-degree phase difference, and thus have mutually-inverted waveforms.

Each of first and second reception signals Rx(2n−1) and Rx(2n), respectively received through the first and second sensing lines, may be a signal that has a certain waveform and includes noise. For example, the first and second reception signals Rx(2n−1) and Rx(2n) may have a waveform, for example, a sine or cosine waveform, and may be respectively demodulated by the demodulators 2310 and 2320 and supplied to the calculation unit 2330.

The calculation unit 2330 may perform an arithmetic processing operation on the received first and second reception signals Rx(2n−1) and Rx(2n). For example, the calculation unit 2330 may perform a subtraction operation to obtain a differential signal. The demodulation operation and the subtraction operation may be performed for each of the two stages, and thus, a differential signal (for example, a first differential signal Diff_1) may be generated in the first stage (Stage 1), and a differential signal (for example, a second differential signal Diff_2) may be generated in the second stage (Stage 2). The generated differential signals Diff_1 and Diff_2 may be supplied to the single-ended signal generator 2400. A differential value of differential touch inputs may be calculated, and thus, the differential signals Diff_1 and Diff_2 supplied to the single-ended signal generator 2400 may be signals with no common mode noise.

The single-ended signal generator 2400 may include a first calculation unit 2410 and a second calculation unit 2420. The first and second calculation units 2410 and 2420 may perform different arithmetic operations. For example, the first calculation unit 2410 may perform a subtraction operation, and the second calculation unit 2420 may perform a summation operation. Also, each of the first calculation unit 2410 and the second calculation unit 2420 may perform an arithmetic operation on the first differential signal Diff_1 and the second differential signal Diff_2. The single-ended signal generator 2400 may include one or more registers 2430 and 2440 to store the first differential signal Diff_1 which is first input temporally.

An arithmetic result from the first calculation unit 2410 may be output as first touch data Data_T(2n−1) corresponding to the first sensing line, and an arithmetic result from the second calculation unit 2420 may be output as second touch data Data_T(2n) corresponding to the second sensing line. The first touch data Data_T(2n−1) and the second touch data Data_T(2n) may be supplied, as single-ended touch signals respectively corresponding to the first and second sensing lines, to the control logic or the touch screen controller or a processor provided outside the touch screen controller, thereby calculating touch coordinates.

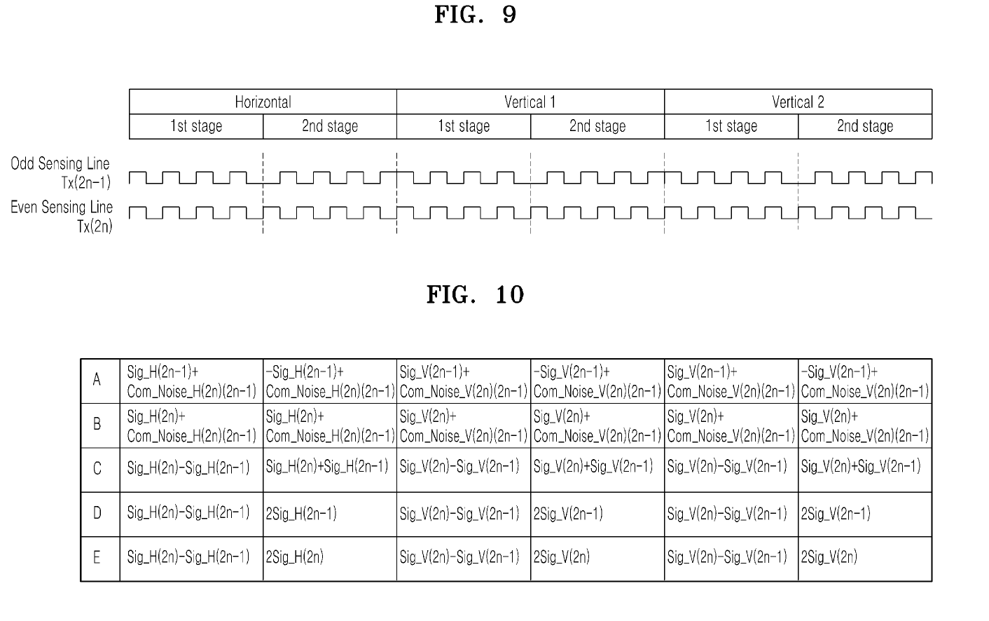

A detailed operation of the touch data generator 2000 of FIG. 7 will be described with reference to FIGS. 8 to 10. FIG. 8 is a circuit diagram illustrating the touch data generator 2000 of FIG. 7, FIG. 9 is a waveform diagram illustrating an example of a modulated transmission signal, and FIG. 10 is a table illustrating an example of signals respectively applied to a plurality of nodes of the touch data generator 2000 of FIG. 7.

As illustrated in FIG. 8, the touch data generator 2000 may include a first touch signal receiver 2210, corresponding to an odd-numbered sensing line (hereinafter referred to as a first sensing line), and a second touch signal receiver 2220 corresponding to an even-numbered sensing line (hereinafter referred to as a second sensing line). Each of the first and second touch signal receivers 2210 and 2220 may include an amplifier, and a first input terminal of the amplifier may be connected to the first sensing line or the second sensing line.

Moreover, the touch data generator 2000 may include a first transmission signal generator 2110, which supplies a modulated first transmission signal Tx(2n−1) to the first sensing line, and a second transmission signal generator 2120 which supplies a modulated second transmission signal Tx(2n) to the second sensing line. The first transmission signal generator 2110 may be connected to a second input terminal of the amplifier included in the first touch signal receiver 2210, and the second transmission signal generator 2120 may be connected to a second input terminal of the amplifier included in the second touch signal receiver 2220. When it is assumed that the amplifiers are in an ideal connection state, the first transmission signal Tx(2n−1) may be transferred to the first input terminal of the amplifier included in the first touch signal receiver 2210, and supplied to the touch screen panel. In the same or similar way, the second transmission signal Tx(2n) may be supplied to the touch screen panel TSP. Also, a touch input signal Rx(2n−1) input to the amplifier (for example, a first amplifier of the first touch signal receiver 2210) and an output from the first amplifier of the first touch signal receiver 2210 may be the same or may differ depending on a gain value of a corresponding amplifier, but hereinafter, it is assumed that the touch input signal Rx(2n−1) input to the first amplifier of the first touch signal receiver 2210 and the output from the first amplifier of the first touch signal recever 2210 may be substantially the same. Such an assumption may be applied identically to an input/output of a second amplifier of the second touch signal receiver 2220.

As illustrated in FIG. 9, a sensing operation on the horizontal lines and the vertical lines of the touch screen panel TSP may be performed. Also, when the number of vertical lines is relatively more that the number of horizontal lines, the sensing operation on the vertical lines may be performed twice (hereinafter referred to as first and second vertical line sensing operations). A horizontal line sensing operation and the first and second vertical line sensing operations are substantially performed identically or similarly, and thus, an embodiment of the inventive concept will be described with reference to the horizontal line sensing operation.

In a first stage (1st stage), the first and second transmission signals Tx(2n−1) and Tx(2n) having the same phase are supplied to the first and second sensing lines. The touch input signal Rx(2n−1) and Rx(2n), respectively corresponding to capacitance changes based on a touch (or hovering) of the touch screen panel TSP, are supplied to the touch signal receivers 2210 and 2220. The touch signal receivers 2210 and 2220 outputs differential touch signals respectively corresponding to the received touch input signal Rx(2n−1) and Rx(2n). For example, in the first stage (1st stage), an output of the first touch signal receiver 2210 is a signal Sig_H(2n−1)+Com_Noise_H(2n)(2n−1) corresponding to a first node A, and as illustrated in FIG. 10, may have a sine waveform including the common mode noise Com_Noise_H(2n)(2n−1). Also, in the first stage (1st stage), an output of the second touch signal receiver 2220 is a signal Sig_H(2n)+Com_Noise_H(2n)(2n−1) corresponding to a second node B, and as illustrated in FIG. 10, may have a sine waveform including the common mode noise Com_Noise_H(2n−1).

The signal processing unit 2300 may include first and second demodulators 2310 and 2320 and a calculation unit 2330. A signal from each of the first and second nodes A and B may be supplied as a differential touch signal to the signal processing unit 2300. A demodulation operation and a subtraction operation on the differential touch signal may be performed. A result of the subtraction operation is a signal Sig_H(2n)+−Sig_H(2n−1) corresponding to a third node C, and as illustrated in FIG. 10, may be a differential signal with no common mode noise.

The single-ended signal generator 2400 may include first and second calculation units 2410 and 2420 and first and second registers 2430 and 2440. A signal of the third node C with no common mode noise may be stored in the first and second registers 2430 and 2440. That is, the signal of the third node C generated in the first stage (1st stage) is stored in the first and second registers 2430 and 2440 in common, and thus, as illustrated in FIG. 10, in the first stage (1st stage), a signal Sig_H(2n)+−Sig_H(2n−1)of a fourth node D and a signal Sig_H(2n)+−Sig_H(2n−1) of a fifth node E may have the same value. The signal of the third node C stored in the first and second registers 2430 and 2440 may be used for an arithmetic operation in a next second stage (2nd stage).

In the second stage (2nd stage), the first and second transmission signals Tx(2n−1) and Tx(2n) having opposite phases are respectively supplied to two adjacent sensing lines. A touch input signal, corresponding to a capacitance change based on a touch (or hovering) of the touch screen panel TSP, is supplied to the touch signal receivers 2210 and 2220.

A signal Sig_H(2n)+Sig_H(2n−1), which is generated by performing a demodulation and calculation operation on differential touch signals respectively corresponding to the first and second touch signal Rx(m) and Rx(m+1) received in the second stage (2nd stage), is supplied to the third node C. A signal Sig_H(2n)+Sig_H(2n−1), which is supplied to the third node C in the second stage (2nd stage), may be a differential signal with no common mode noise Com_Noise_H(2n)(2n−1), and the differential signal in the second stage (2nd stage) is supplied to the first and second calculation units 2410 and 2420 of the single-ended signal generator 2400.

An arithmetic operation is performed on the two differential signals obtained through the two stages (1st stage and 2nd stage). For example, the first calculation unit 2410 may perform a subtraction operation on the two differential signals, and the second calculation unit 2420 may perform a summation operation on the two differential signals. A single-ended touch signal, corresponding to a capacitance change for each of two adjacent sensing lines, may be calculated according to results of the subtraction operation and summation operation. As illustrated in FIG. 10, a single-ended touch signal 2Sig_H(2n−1) corresponding to the first sensing line is supplied to the fourth node D, and a single-ended touch signal 2Sig_H(2n) corresponding to the second sensing line is supplied to the fifth node E. By performing an arithmetic operation on the single-ended touch signals and a predetermined reference value (not shown), a capacitance change value for each of the first and second sensing lines may be calculated.

The operations of generating touch data may be identically or similarly performed for the vertical sensing lines. For example, a touch data generating operation on the vertical sensing lines may be performed twice. A transmission signal may be time-division coded and provided in a first vertical sensing line detection section, and a single-ended touch signal may be generated by performing an arithmetic operation on a differential signal (which is calculated in a first stage) and a differential signal calculated in a second stage. The same operation may be performed in a second vertical sensing line detection section.

According to the differential touch sensing method based on the demodulation scheme to calculate touch data, only one signal processing unit may be needed as a resource necessary to implement a corresponding system to correspond to two horizontal sensing lines, and thus, only signal processing units corresponding to a half of the total number of horizontal lines may be provided, thereby decreasing the total number of resources. This may be applied identically to the vertical sensing lines. Also, instead of differential touch data, a single-ended touch signal may be reported as touch data to a post-processing system, and thus, a processing operation of calculating touch coordinates is simplified, and an error term is prevented from occurring.

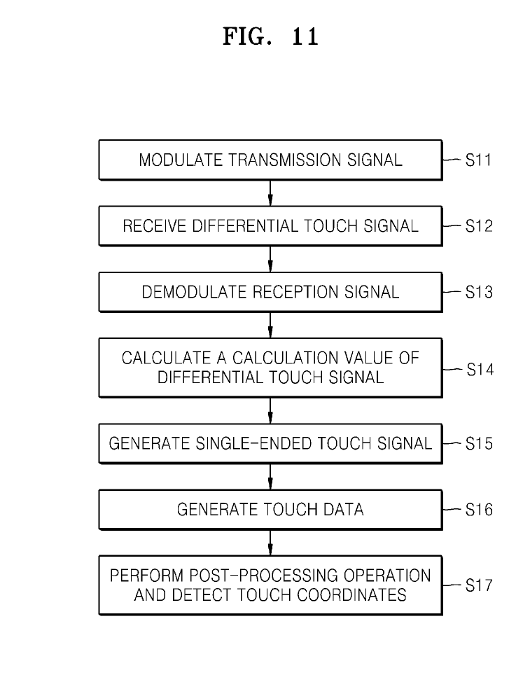

FIG. 11 is a flowchart illustrating an operating method of a touch screen controller according to an embodiment of the inventive concept.

First, the touch screen controller modulates a transmission signal Tx in operation S11. In modulating the transmission signal Tx, the touch screen controller supplies transmission signals Tx, of which at least one of frequencies and phases have different values, to two adjacent sensing lines. As in the above-described embodiment, arbitrary one base signal may be time-division coded, or the transmission signal Tx may be generated by combining two or more base signals.

A differential touch input is excited by supplying the transmission signal Tx, and a differential touch signal corresponding thereto is received by the touch data generator of the touch screen controller in operation S12. A demodulation operation is performed on the received differential touch signal (reception signal) in operation S13, and a calculation value for the demodulated differential touch signal is calculated in operation S14. A single-ended touch signal corresponding to each sensing line is generated according to the calculation result of the calculation value in operation S15, and touch data based on the generated single-ended touch signal is generated in operation S16. The generated touch data is supplied to a system for a post-processing operation, and for example, touch coordinates are detected through the post-processing operation performed by the control logic of the touch screen controller, in operation S17.

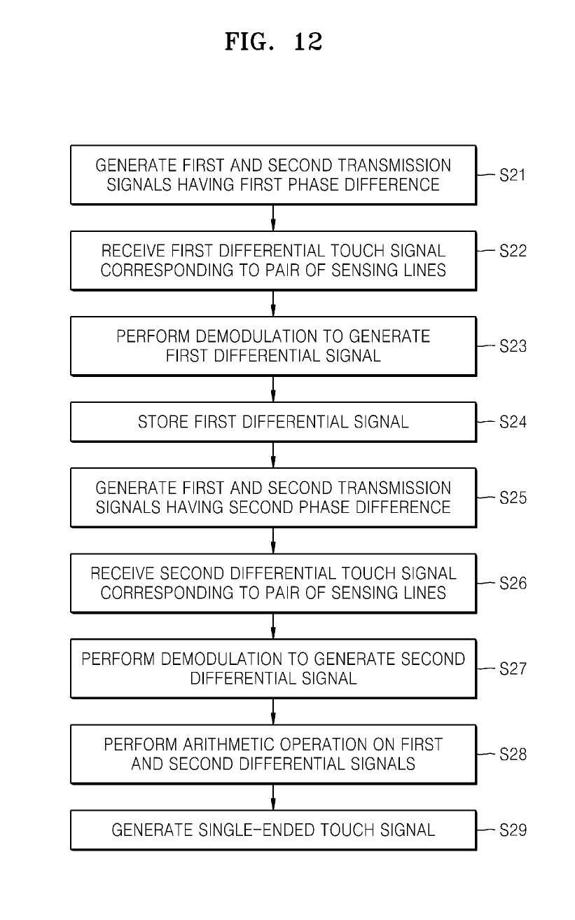

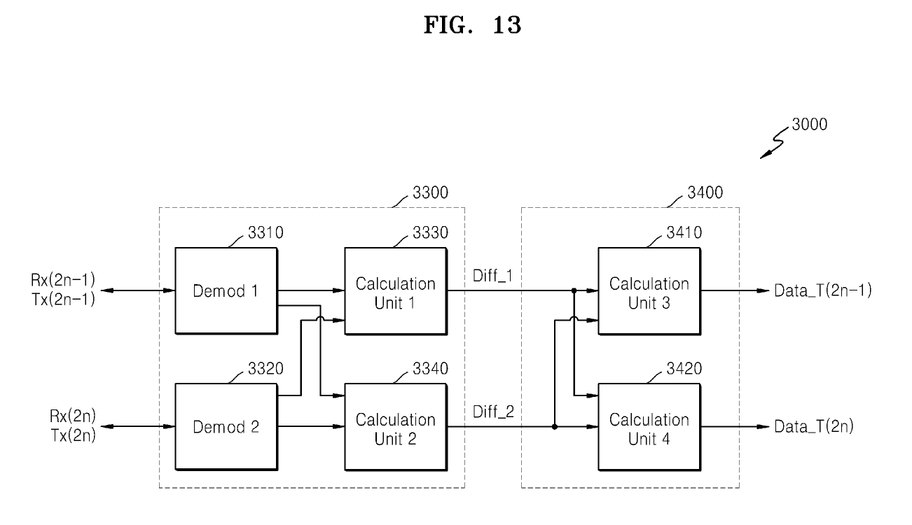

FIG. 12 is a flowchart illustrating an operating method of a touch screen controller according to an embodiment of the inventive concept. FIG. 12 illustrates an operation of generating a single-ended touch signal through a modulation of a transmission signal having a time-division characteristic as described above.

First, two stages may be defined for a sensing operation on the horizontal sensing lines (or the vertical sensing lines). In a first stage, first and second transmission signals having a first phase difference are generated in correspondence with a pair of sensing lines (for example, first and second sensing lines) in operation S21. The first phase difference has a certain value, and for example, the first and second transmission signals may have the same phase value.

First and second reception signals are excited according to the first and second transmission signals being respectively supplied to the first and second sensing lines, and the first and second reception signals are received as first differential touch signals corresponding to the first and second sensing lines in operation S22. A demodulation and calculation operation for the received first differential touch signals is performed, and for example, a first differential signal is generated through a subtraction operation, in operation S23. The generated first differential signal may be temporarily stored to be used for an arithmetic operation in a second stage, in operation S24.

Subsequently, the second stage for the sensing operation on the horizontal sensing lines (or the vertical sensing lines) is performed. In the second stage, first and second transmission signals having a second phase difference are generated to correspond to a pair of sensing lines (for example, first and second sensing lines) in operation S25. The second phase difference has a certain value, and for example, the first and second transmission signals may have a 180-degree phase value. That is, the first and second transmission signals have mutually-inverted waveforms.

A second differential touch signal is received according to the first and second transmission signals (having the 180-degree phase difference) being respectively supplied to the first and second sensing lines, in operation S26.

In operation S27, a second differential signal is generated through the above-described demodulation and calculation operation, in operation S27. In operation S28, an arithmetic operation is performed on the first differential signal generated in the first stage and the second differential signal generated in the second stage. In operation S29, a single-ended touch signal is generated according to a result of the arithmetic operation, and for example, a first single-ended touch signal corresponding to the first sensing line may be generated through one of a summation operation and a subtraction operation for the first and second differential signals. Also, a second single-ended touch signal corresponding to the second sensing line may be generated through the other of the summation operation and subtraction operation for the first and second differential signals.

FIG. 13 is a block diagram illustrating a touch data generator 3000 of a touch screen controller according to an embodiment of the inventive concept. FIG. 13 illustrates an implementation example of each of a signal processing unit and a single-ended signal generator which are included in a touch data generator.

As illustrated in FIG. 13, the touch data generator 3000 may include a signal processing unit 3300 and a single-ended signal generator 3400. The signal processing unit 3300 may include one or more demodulators 3310 and 3320 and one or more calculation units 3330 and 3340. Also, the single-ended signal generator 3400 may include one or more calculation units 3410 and 3420.

First and second transmission signals Tx(2n−1) and Tx(2n), having a certain frequency through a modulation operation, may be supplied to the touch screen panel, and at least one of phases and frequencies of the first and second transmission signals Tx(2n−1) and Tx(2n) may have different values. In the present embodiment, a space-division method may be applied in modulating a transmission signal, and for example, two or more base signals having different phases are coded and combined into two codes (for example, 1 and 1 or 1 and -1), thereby generating the first and second transmission signals Tx(2n−1) and Tx(2n) respectively supplied to first and second sensing lines. In an embodiment, a signal (for example, a signal obtained by summating two base signals) obtained by performing a first arithmetic operation on two base signals having a 90-degree phase difference may be generated as the first transmission signal Tx(2n−1), and a signal (for example, a signal obtained by performing a subtraction operation on the two base signals) obtained by performing a second arithmetic operation on the two base signals may be generated as the second transmission signal Tx(2n).

As the one or more demodulators 3310 and 3320, a first demodulator 3310 receives a first reception signal Rx(2n−1), and performs a demodulation operation on the first reception signal Rx(2n−1). Also, a second demodulator 3320 receives a second reception signal Rx(2n), and performs a demodulation operation on the second reception signal Rx(2n). Each of the first and second demodulators 3310 and 3320 may include two or more demodulators, in correspondence with a transmission signal being generated by combining two base signals. For example, the first demodulator 3310 may include a demodulator, which performs a first-scheme processing operation, and a demodulator which performs a second-scheme processing operation. Also, the second demodulator 3320 may include a demodulator, which performs the first-scheme processing operation, and a demodulator which performs the second-scheme processing operation.

Moreover, as the one or more calculation units 3330 and 3340, a first calculation unit 3330 performs a first arithmetic operation on signals from the first and second demodulators 3310 and 3320, and a second calculation unit 3340 performs a second arithmetic operation on the signals from the first and second demodulators 3310 and 3320. For example, the first calculation unit 3330 may perform a subtraction operation on the first and second reception signals Rx(2n−1) and Rx(2n) obtained through demodulation based on the first method, thereby generating a first differential signal Diff_1. The second calculation unit 3340 may perform a summation operation on the first and second reception signals Rx(2n−1) and Rx(2n) obtained through demodulation based on the second method, thereby generating a second differential signal Diff_2.

The first and second differential signals Diff_1 and Diff_2 may be generated by performing a demodulation and calculation processing operation on the differential touch signals as described above, and supplied to the single-ended signal generator 3400. The single-ended signal generator 3400 may include a first calculation unit 3410 and a second calculation unit 3420. The first calculation unit 3410 may perform an arithmetic operation on the first and second differential signals Diff_1 and Diff_2 to generate first touch data Data_T(2n−1) corresponding to the first sensing line, and the second calculation unit 3420 may perform an arithmetic operation on the first and second differential signals Diff_1 and Diff_2 to generate second touch data Data_T(2n) corresponding to the second sensing line. For example, the first calculation unit 3410 may perform a subtraction operation on the first and second differential signals Diff_1 and Diff_, and the second calculation unit 3420 may perform a summation operation on the first and second differential signals Diff_1 and Diff_2.

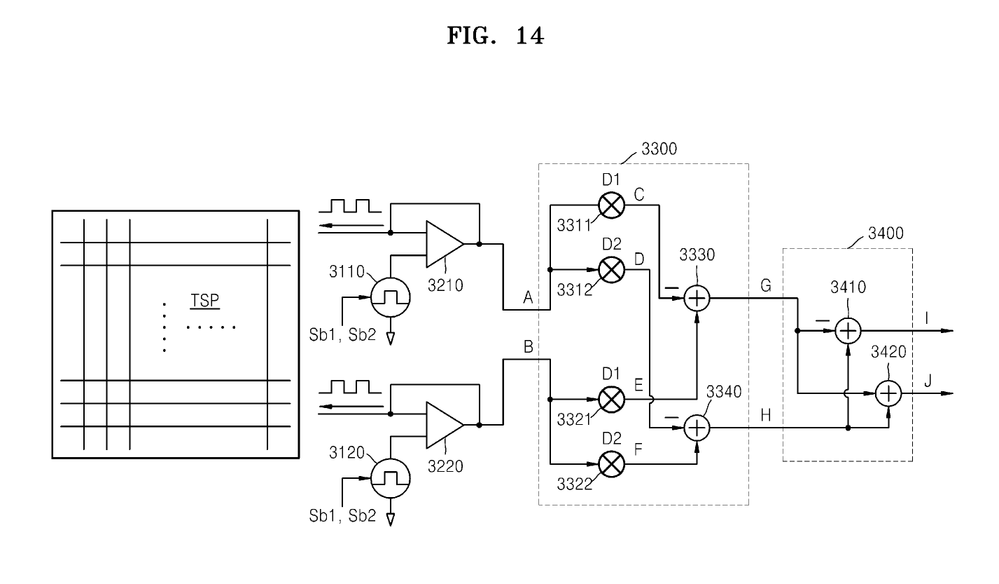

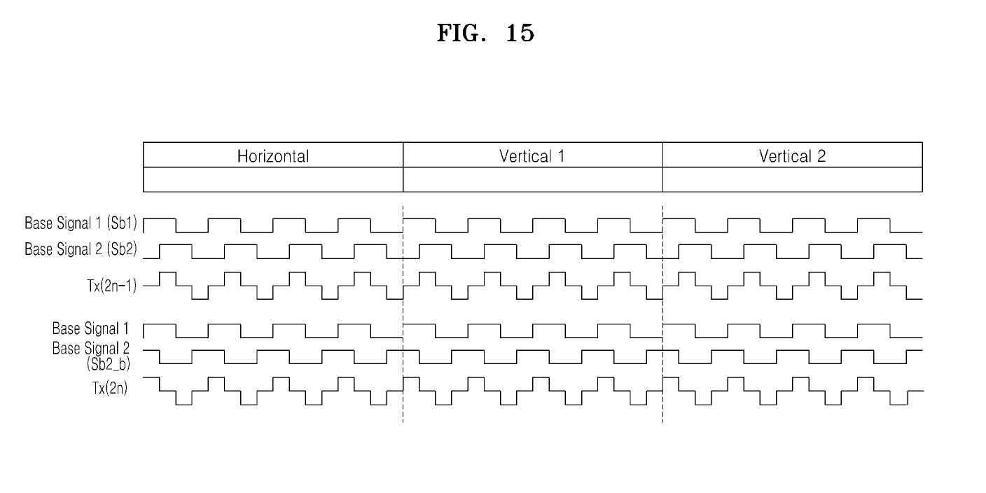

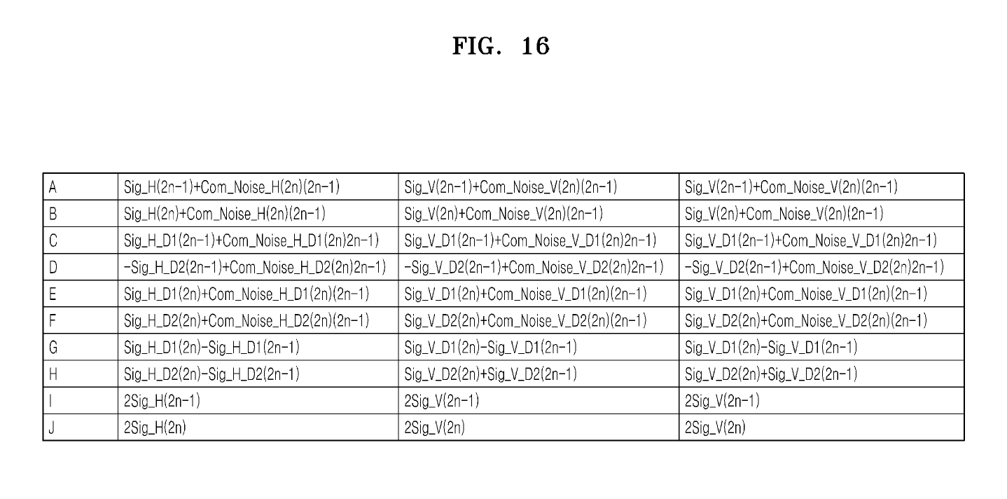

A detailed operation of the touch data generator 3000 of FIG. 13 will be described with reference to FIGS. 14 to 16. FIG. 14 is a circuit diagram illustrating the touch data generator 3000 of FIG. 13, FIG. 15 is a waveform diagram illustrating an example of a modulated transmission signal, and FIG. 16 is a table illustrating signals respectively applied to a plurality of nodes of the touch data generator 3000. Similarly to the above-described embodiment, a horizontal line sensing operation and first and second vertical line sensing operations are substantially performed identically or similarly, and thus, an embodiment of the inventive concept will be described with reference to the horizontal sensing line operation.

As illustrated in FIG. 14, the touch data generator 3000 may include a first touch signal receiver 3210, corresponding to an odd-numbered sensing line (hereinafter referred to as a first sensing line), and a second touch signal receiver 3220 corresponding to an even-numbered sensing line (hereinafter referred to as a second sensing line). Also, the touch data generator 3000 may include a first transmission signal generator 3110, which supplies a modulated first transmission signal to the first sensing line, and a second transmission signal generator 3120 which supplies a modulated second transmission signal to the second sensing line.

As illustrated in FIG. 15, each of the first and second transmission signal generators 3110 and 3120 generates the first and second transmission signals Tx(2n−1) and Tx(2n) by using two base signals Sb1 and Sb2. For example, first and second base signals Sb1 and Sb2 may have the same frequency, and may be signals of which phases have an orthogonal relationship. In combining the first and second base signals Sb1 and Sb2, for example, a signal obtained by summating the first and second base signals Sb1 and Sb2 may be generated as the first transmission signal Tx(2n−1). Also, the phase of the second base signal Sb2 is inverted, and then, a signal obtained by summating the first base signal Sb1 and the phase-inverted base signal Sb2 may be generated as the second transmission signal Tx(2n).

A signal Sig_H(2n−1)+Com_Noise_H(2n)(2n−1), which includes the common mode noise along with a component having a certain waveform (for example, a sine waveform) as shown in FIG. 16, may be supplied to a first node A connected to an output terminal of the first touch signal receiver 3210. Similarly, a signal Sig_H(2n)+Com_Noise_H(2n)(2n−1), which includes the common mode noise along with a component having a certain waveform (for example, the sine waveform) as illustrated in FIG. 16, may be supplied to a second node B connected to an output terminal of the second touch signal receiver 3220.

As described above, the first demodulator 3310 may include two or more demodulators. For example, the first demodulator 3310 may include a first modulation unit 3311, which performs a first-scheme modulation operation to correspond to each of the two base signals Sb1 and Sb2, and a second modulation unit 3312 which performs a second-scheme modulation operation to correspond to each of the two base signals Sb1 and Sb2. Similarly, the second demodulator 3320 may include a third modulation means 3321, which performs the first-scheme modulation operation, and a fourth modulation means 3322 which performs the second-scheme modulation operation. The first and second reception signals Rx(2n−1) and Rx(2n) may be separated into orthogonal signals by the first-scheme modulation operation and the second-scheme modulation operation. Although not illustrated in FIG. 14, the signal processing unit 3300 may further include a circuit that compensates for delay occurring in a routing process of a differential touch signal to increase an accuracy of demodulation,.

Signals of nodes (for example, third to sixth nodes C, D, E and F), which are connected to respective output terminals of the first to fourth modulation means 3311, 3312, 3321 and 3322, are as listed in the table of FIG. 16. A signal Sig_H-D1(2n)−Sig_H_D2(2n−1) of a seventh node G is generated by performing a subtraction operation on the signals of the third and fifth nodes C and E, and a signal Sig_H-D1(2n)−Sig_H_D2(2n−1) of an eighth node H is generated by performing a subtraction operation on the signals of the fourth and sixth nodes D and F.

By the above-described demodulation and calculation operation, a differential signal including the signals Sig_H(2n−1) and Sig_H(2n) of the seventh and eighth nodes G and H is supplied to the single-ended signal generator 3400. The single-ended signal generator 3400 performs a first arithmetic operation and a second arithmetic operation on the differential signal. For example, the first calculation unit 3410 may perform a subtraction operation on the differential signal to supply a signal of a ninth node I as a single-ended touch signal corresponding to the first sensing line, and the second calculation unit 3420 may perform the subtraction operation on the differential signal to supply a signal of a tenth node J as a single-ended touch signal corresponding to the second sensing line.

According to the above-described operation, the common mode noise is removed from capacitance values, based on a touch motion, of the first and second sensing lines, and the capacitance values are calculated. Also, a capacitance change amount of each of the first and second sensing lines based on the touch motion is calculated by performing an arithmetic operation on a reference value at a certain time and a single-ended touch signal. In addition, according to the above-described embodiment, a sensing time is reduced by half compared to the sensing operation in the above-described second stage.

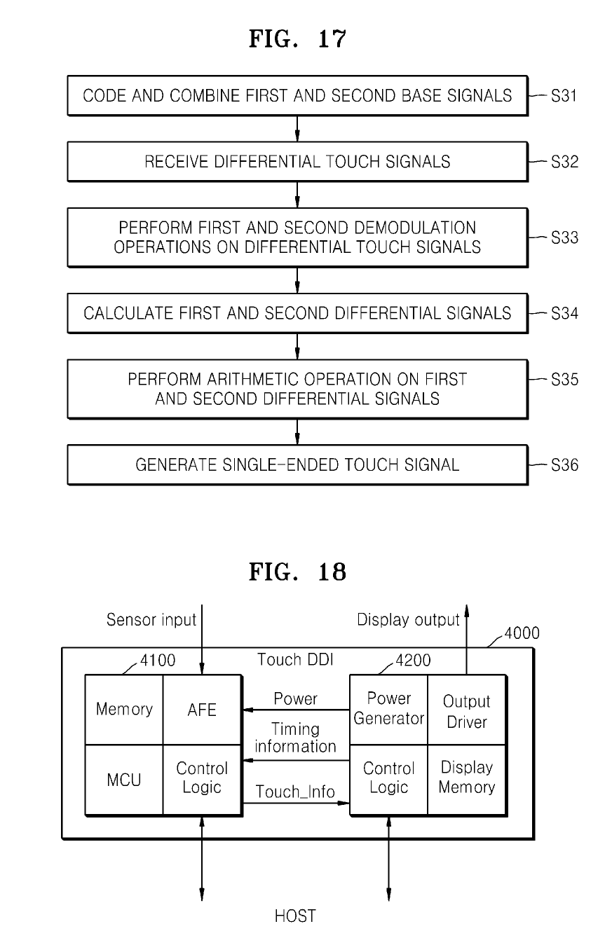

FIG. 17 is a flowchart illustrating an operating method of a touch screen controller according to an embodiment of the inventive concept. FIG. 17 illustrates an example in which a transmission signal is generated by coding and combining two base signals having different phases, and a single-ended touch signal is generated from the transmission signal.

In operation S31, the touch screen controller performs a coding operation and/or a combining operation on first and second base signals having different phases to generate first and second transmission signals to be supplied to adjacent sensing lines. For example, the first and second base signals may have a certain phase difference, and may be signals having an orthogonal relationship. The first transmission signal may be generated by summating the first and second base signals, and the second transmission signal may be generated by summating the first base signal and a phase-inverted second base signal.

The first and second transmission signals are respectively supplied to adjacent first and second sensing lines, and thus, first and second reception signals are respectively excited to the first and second sensing lines. In operation S32, the excited first and second reception signals are received as differential touch signals by the touch data generator of the touch screen controller.

In operation S33, a demodulation operation for the differential touch signals are performed in response to a modulation of each of the first and second base signals. For example, a first differential touch signal may be generated by performing a first-scheme demodulation operation on the differential touch signals, and a second differential touch signal may be generated by performing a second-scheme demodulation operation on the differential touch signals. A differential signal of the demodulated differential signals may be calculated. For example, a first differential signal may be calculated by performing a subtraction operation on the first differential touch signal, and a second differential signal may be calculated by performing a subtraction operation on the second differential touch signal in operation S34.

Touch data may be generated from the calculated first and second differential signals. For example, an arithmetic operation for the first and second differential signals is performed in operation S35. For example, a first single-ended signal corresponding to the first sensing line may be generated by performing a subtraction operation on the first and second differential signals, and a second single-ended signal corresponding to the second sensing line may be generated by performing a summation operation on the first and second differential signals, in operation S36. This is merely an example of calculating a single-ended touch signal, and the single-ended touch signal may be generated from a differential signal through various other arithmetic operations.

FIG. 18 is a block diagram illustrating a touch display driving intergrated circuit (touch DDI) including a touch screen controller according to an embodiment of the inventive concept. The touch screen controller according to an embodiment of the inventive concept may be implemented as an integrated chip (IC) type which is integrated into one chip along with a DDI that drives a display panel to output an image. The manufacturing cost is reduced by integrating the touch screen controller and the DDI into one semiconductor chip. Also, various timing signals relating to a display operation are used for a touch data generating operation, and thus, the influence of noise is reduced on an operation of a touch screen.

As illustrated in FIG. 18, a semiconductor chip 4000 to drive the display panel may include a touch controller 4100 and a display driver 4200. The touch controller 4100 may include a memory, an analog front end (AFE), a micro control unit (MCU), and a control logic. The display driver 4200 may include a power generator, an output driver, a control logic, and a display memory. The touch controller 4100 and the display driver 4200 may exchange at least one piece of information such as timing information, state information, etc. Also, the touch controller 4100 and the display driver 4200 may supply or receive a source voltage.

In FIG. 8, for convenience of description, the touch controller 4100 and the display driver 4200 are briefly illustrated. The AFE included in the touch controller 4100 may be a functional block that includes the transmission signal generator, the touch signal receiver, the signal processing unit, and the single-ended signal generator according to the above-described embodiments. Touch data generated from the AFE may be supplied to a host or the display driver 4200, and touch coordinates may be calculated based on the touch data. Also, at least one of the above-described embodiments may be applied to the AFE, and thus, the AFE may perform an operation that calculates a differential signal for a differential touch signal, and performs an arithmetic operation on the differential signal to calculate a single-ended signal.

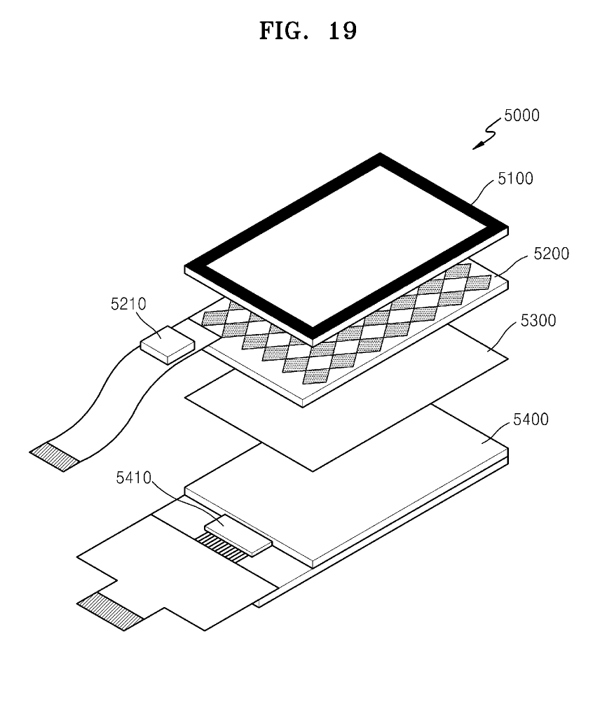

FIG. 19 is a diagram illustrating a display apparatus 5000 having a printed circuit board (PCB) structure integrated with a touch screen panel according to an embodiment of the inventive concept. FIG. 19 illustrates the display apparatus 5000 having a structure in which a touch screen panel and a display panel are separated from each other.

As illustrated in FIG. 19, the display apparatus 5000 may include a window glass 5100, a touch screen panel 5200, and a display panel 5400. Also, a polarizer 5300 may be further disposed between the touch screen panel 5200 and the display panel 5400, for providing an optical characteristic.

The window glass 5100 may be generally formed of a material such as acryl or tempered glass, and may protect a module against a scratch caused by an external impact or a repeated touch. The touch screen panel 5200 is formed by patterning electrodes on a glass substrate or a polyethylene terephthalate (PET) film by using a transparent electrode such as indium tin oxide (ITO). The touch screen controller 5210 may be mounted on a flexible printed circuit board (FPCB) in a chip-on board (COB) type. The touch screen controller 5210 may sense a capacitance change from each of the electrodes to extract touch coordinates, and supply the touch coordinates to a host. The display panel 5400 is generally formed by bonding two glass substrates that respectively correspond to an upper substrate and a lower substrate. Also, in a display panel for mobile equipment, the DDI 5410 may be provided as a chip-on glass (COG) type. Although FIG. 19 illustrates an example in which the touch screen controller and the DDI are implemented as separate chips, but as described above, the touch screen controller and the DDI may be integrated into one chip, and equipped in the display apparatus 5000.

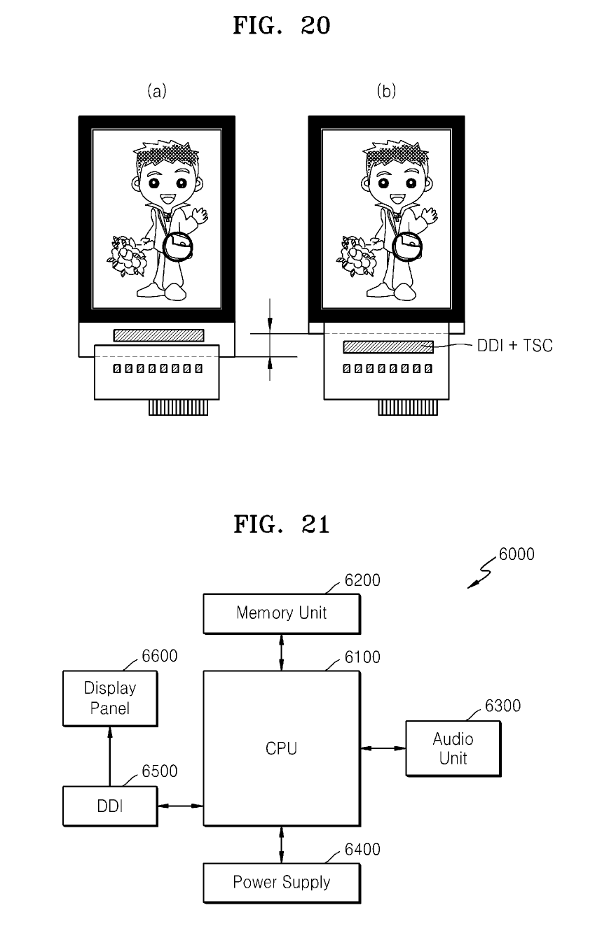

FIG. 20 includes two views (a) and (b) illustrating the display apparatus equipped with a semiconductor chip with a built-in touch screen controller according to an embodiment of the inventive concept. The view (a) of FIG. 20 illustrates an example in which a semiconductor chip is disposed on a glass substrate of a display panel in the COG type, and the view (b) of FIG. 20 illustrates an example in which a semiconductor chip is disposed on a film of a display panel in the COF type. When the touch screen controller and a DDI are implemented as separate chips, the touch controller may be provided as the COF type, and the DDI may be provided as the COG. Also, in an embodiment, a semiconductor chip in which the touch screen controller and the DDI are integrated may be provided as one of the COG type and the COF type.

FIG. 21 is a block diagram illustrating a user apparatus (electronic apparatus) 6000 including a touch screen controller according to an embodiment of the inventive concept. As illustrated in FIG. 21, the user apparatus 6000 may include a central processing unit (CPU) 6100, a memory unit 6200, an audio unit 6300, and a power supply 6400, and a display driving IC (DDI) 6500, and a display panel 6600. The touch screen controller according to the embodiments of the inventive concept may be included in the DDI 6500.

The CPU 6100 controls an overall operation of the user apparatus 6000. for example, the CPU 6100 may control a booting operation of the user apparatus 6000 according to power being supplied thereto. Alternatively, the CPU 6100 may drive a firmware used to control the user apparatus 6000. The firmware may be loaded into the memory unit 6200, and driven.

The memory unit 6200 may include a volatile memory device, such as a dynamic random access memory (DRAM), or a nonvolatile memory device such as a read-only memory (ROM) or a flash memory device. For example, the memory unit 6200 may store an operating system (OS), an application program, and a firmware which are used to drive the user apparatus 6000. Also, the OS, the application program, and the firmware may be loaded into the volatile memory device included in the memory unit 6200 according to a control of the CPU 6100.

The audio unit 6300 may reproduce voice data according to a control of the CPU 6100, and the power supply 6400 may supply power necessary to drive the user apparatus 6000. The DDI 6500 may include the touch screen controller according to the above-described embodiment. The DDI 6500 may detect a capacitance change of each sensing unit of the touch screen panel (not shown) included in the display panel 6600 to generate touch data. For example, the touch screen controller of the DDI 6500 may include the touch data generator that modulates one or more base signals to generate a transmission signal, and performs a demodulation and calculation operation on a differential touch signal (which is excited from the transmission signal) to generate a single-ended signal. Also, the DDI 6500 may perform an operation of detecting touch coordinates from the single-ended signal, or the CPU 6100 may perform an operation of detecting touch coordinates based on the touch data from the DDI 6500. The user apparatus 6000 may include an interface to communicate with an external apparatus using a wired or wireless communication method to transmit to or receive from the external apparatus data usable to control or operate the display panel 6600 and the audio unit 6300. The user apparatus 6000 may further include a user interface to control components the user apparatus 6000, and portions of the DDI 6500 and the display panel 660 may be usable to receive touch data as a user input to control the user apparatus 6000.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a blue-ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A touch screen controller comprising:
a touch data generator that supplies a first transmission signal to a first sensing line, supplies a second transmission signal to a second sensing line adjacent to the first sensing line, receives differential touch signals from the first and second sensing lines, and performs an arithmetic operation on the differential touch signals to generate a single-ended touch signal; and
a control logic that calculates touch coordinates by using the single-ended touch signal from the touch data generator,
wherein at least one of phases and frequencies of the first and second transmission signals has a different value from the other one thereof, and
the touch data generator comprises a transmission signal generator to generate the first and second transmission signals having the same frequency and different phases.

2. The touch screen controller of claim 1, wherein the touch data generator further comprises a touch signal receiver to receive the differential touch signals which are excited according to the first and second transmission signals.

3. The touch screen controller of claim 2, wherein the touch data generator further comprises a signal processing unit, the signal processing unit includes:
a first demodulator to demodulate a first touch signal from the first sensing line; and
a second demodulator to demodulate a second touch signal from the second sensing line,
wherein the signal processing unit performs the arithmetic operation on outputs of the first and second demodulators to calculate at least one differential signal corresponding to the differential touch signals.

4. The touch screen controller of claim 3, wherein the touch data generator further comprises:
a single-ended signal generator to generate a first single-ended touch signal corresponding to the first sensing line and a second single-ended touch signal corresponding to the second sensing line, based on the arithmetic operation using the at least one differential signal.

5. The touch screen controller of claim 1, wherein,
in a first stage, the touch data generator generates the first and second transmission signals having the same phase, and
in a second stage, the touch data generator generates the first and second transmission signals having different phases.

6. The touch screen controller of claim 5, wherein the touch data generator generates a first differential signal by performing a demodulation and subtraction operation on a first differential touch signal received in the first stage, generates a second differential signal by performing a demodulation and subtraction operation on a second differential touch signal received in the second stage, and generates the single-ended touch signal by performing the arithmetic operation on the first and second differential signals.

7. The touch screen controller of claim 6, wherein the touch data generator generates a first single-ended touch signal corresponding to the first sensing line, based on a subtraction operation on the first and second differential signals, and generates a second single-ended touch signal corresponding to the second sensing line, based on a summation operation on the first and second differential signals.

8. The touch screen controller of claim 1, wherein the touch data generator receives two base signals having different phases, combines the two base signals in a first scheme to generate the first transmission signal, and combines the two base signals in a second scheme to generate the second transmission signal.

9. The touch screen controller of claim 8, wherein the touch data generator performs a first demodulation operation on the differential touch signals to generate first and second signals, performs a second demodulation operation on the differential touch signals to generate third and fourth signals, performs a first arithmetic operation on the first and second signals to generate a first differential signal, and performs a second arithmetic operation on the third and fourth signals to generate a second differential signal.

10. The touch screen controller of claim 9, wherein the touch data generator generates a first single-ended touch signal corresponding to the first sensing line, based on a subtraction operation on the first and second differential signals, and generates a second single-ended touch signal corresponding to the second sensing line, based on a summation operation on the first and second differential signals.

11. The touch screen controller of claim 1, wherein the touch data generator receives at least one base signal, codes the at least one base signal to generate the first and second transmission signals, performs a first arithmetic operation on the differential touch signals to generate a first single-ended touch signal corresponding to the first sensing line, and performs a second arithmetic operation on the differential touch signals to generate a second single-ended touch signal corresponding to the second sensing line.

12. The touch screen controller of claim 1, wherein the touch data generator comprises:
a transmission signal generator to generate the first and second transmission signals of which at least one of frequencies and phases has a different value from the other one, supplies the first transmission signal to the first sensing line, supplies the second transmission signal to the second sensing line adjacent to the first sensing line;
a touch signal receiver to receive the differential touch signals from the first and second sensing lines; and
a signal processing unit to process the differential touch signals to output at least one signal which is usable to calculate touch coordinates.

13. The touch screen controller of claim 12, wherein the transmission signal generator receives at least one base signal, and performs a modulation operation on the at least one base signal to generate the first and second transmission signals having different phases.

14. The touch screen controller of claim 13, wherein the signal processing unit performs a demodulation operation, corresponding to the modulation operation, on the differential touch signal.

15. The touch screen controller of claim 12, further comprising:
a single-ended signal generator to receive at least one differential signal corresponding to the differential touch signals from the signal processing unit, and performs the arithmetic operation on the at least one differential signal to generate the single-ended touch signal.

16. The touch screen controller of claim 15, wherein,
in a first stage, the first and second transmission signals having the same phase are generated, and a first differential signal is supplied to the single-ended signal generator by performing a first arithmetic operation on the differential touch signals corresponding to the first and second transmission signals,
in a second stage, the first and second transmission signals having opposite phases are generated, and a second differential signal is supplied to the single-ended signal generator by performing a second arithmetic operation on the differential touch signals corresponding to the first and second transmission signals, and
wherein the single-ended signal generator performs the first and second arithmetic operations on the first and second differential signals to generate a first single-ended touch signal corresponding to the first sensing line and a second single-ended touch signal corresponding to the second sensing line, respectively.

17. The touch screen controller of claim 15, wherein,
the first transmission signal is generated by performing a first-scheme modulation operation on first and second base signals, and a first differential signal is supplied to the single-ended signal generator by performing a differential touch signal corresponding to the first transmission signal,
the second transmission signal is generated by performing a second-scheme modulation operation on the first and second base signals, and a second differential signal is supplied to the single-ended signal generator by performing a differential touch signal corresponding to the second transmission signal, and
the single-ended signal generator performs first and second arithmetic operations on the first and second differential signals to generate a first single-ended touch signal corresponding to the first sensing line and a second single-ended touch signal corresponding to the second sensing line, respectively.

18. A display driving integrated circuit (DDI) usable with an electronic apparatus, comprising:
a display driver that realizes an image in a panel including sensing lines; and
the touch screen controller of claim 1 to be integrated with the display driver to share the timing information with the display driver.

19. The DDI of claim 18, wherein the touch data generator of the touch screen controller comprises a signal processing unit having a demodulator to generate a differential signal from the differential touch signals such that the differential signal can be processed to generate the single-ended touch signal.

20. The DDI of claim 19, further comprising:
a control logic to calculate touch coordinates by using the single-ended touch signal from the touch data generator.

21-30. (canceled)
